(19) United States
(12) Patent Application Publication
(10) Pub. No.: US 2024/0007311 A1
(43) Pub. Date: Jan. 4, 2024

(54) SYSTEM AND METHOD FOR DECENTRALIZED SECURE COMMUNICATIONS

(71) Applicant: YAHOO ASSETS LLC, Dulles, VA (US)

(72) Inventors: Mohit Goenka, Santa Clara, CA (US); Nikita Varma, Milpitas, CA (US); Ashish Khushal Dharamshi, Sunnyvale, CA (US); Gnanavel Shanmugam, San Jose, CA (US)

(21) Appl. No.: 17/855,941

(22) Filed: Jul. 1, 2022

(51) Int. Cl. H04L 9/00; H04L 9/32; H04L 51/48; G06F 21/62

(52) U.S. Cl. CPC H04L 9/50; H04L 9/3239; H04L 9/3247; H04L 51/48; G06F 21/6218

(57) ABSTRACT

The present teaching relates to method, system, medium, and implementations for communication. A communication chain with multiple chain units is used to represent a communication thread involving multiple users. Each chain unit includes first information related to a piece of communication in the communication thread and second information for authenticating a request to access the piece of communication. When a request is received with third information from one of the users to access a specific piece of communication in the communication thread in a corresponding chain unit, the user is authenticated based on the third information and the second information in the chain unit for the specific piece of communication. The requested access is facilitated when the user is authenticated.

### BACKGROUND

### 1. Technical Field

The present teaching generally relates to computers. More specifically, the present teaching relates to communications.

### 2. Technical Background

With the development of the Internet and the ubiquitous network connections, a large percent of communications is nowadays performed via the Internet, whether it is via emails, messaging, social media information exchanges, or voice over IP. Such communications are usually managed in a centralized manner. FIG. 1A (PRIOR ART) illustrates an example conventional system 100, that provides communication services to users. In FIG. 1A, a centralized service provider 110 is connected with a plurality of users and includes a communication service engine 120, a centralized communication database 130, and a user database 140. Users receiving services from the centralized service provider 110 communicate with each other through the centralized service provider 110. For instance, a sender user 150 may initiate a communication thread by sending a communication to k recipient users 160, e.g., recipient 1 160-1, recipient 2 160-2, recipient 3 160-3, . . . , recipient i 160-i, . . . , recipient k 160-k and any of the recipients may respond, if permitted, to a message in the communication thread.

To facilitate such back and forth communication among a group of users, the centralized service provider 110 functions by sending copies of the communication thread to all involved. To do so, the communication service engine 120 may store the initial communication from the sender 150 in the centralized communication database 130 and then a copy of the initial communication to each of all named recipients. This is illustrated in FIG. 1B (PRIOR ART), where the initial communication from sender (S) 150 is sent to each of the k recipients (R1, R2, . . . , Rk) with a separate copy, i.e., copy c11 for recipient 1 (R1) 160-1, copy c12 for recipient 2 (R2) 160-2, . . . , copy clk for recipient k (Rk) 160-k. In some systems, all copies of the initial communication sent to different recipients may also be stored in the centralized communication database 130.

If a recipient, e.g., recipient 2 (R2), decides to respond the initial communication to all (including the sender and all other recipients), R2's response is sent, together with the initial communication, to all others (including other recipients and the sender), each of which will receive a separate copy, as shown in FIG. 1B, where copy c21 to R1, c22 to R2, . . . , c2k to Rk, and c2(k+1) to the sender. All the copies may also be stored in the centralized communication database 130, as a record to each user of the system. Other recipients receiving the initial communication may also respond in a similar way, creating more copies (not shown). After the first round, there may be second round of responses. For example, recipient k Rk may respond to all, yielding copy c31 to R1, c32 to R2, . . . , c3k to Rk, and c3(k+1) to the sender. Thus, many copies of the same communication are created and stored, not only taking much of the memory space for storage but also the bandwidth on the network.

In some convention communication system, during the process of creating multiple copies and forwarding and replying among users, there is no restriction on security or privacy of the communication content because content of any part of a communication thread can be modified by anyone. As such, there is no way to authenticate or validate the content that is being transmitted or forwarded from one to another.

Thus, there is a need for a solution that addresses the challenges discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for communication. A communication chain with multiple chain units is used to represent a communication thread involving multiple users. Each chain unit includes first information related to a piece of communication in the communication thread and second information for authenticating a request to access the piece of communication. When a request is received with third information from one of the users to access a specific piece of communication in the communication thread in a corresponding chain unit, the user is authenticated based on the third information and the second information in the chain unit for the specific piece of communication. The requested access is facilitated when the user is authenticated.

In a different example, a system is disclosed for communication. The system includes a communication chain, a communication controller, an authentication unit, and a storage management mechanism. The communication chain includes multiple chain units and represents a communication thread involving a plurality of users. Each chain unit represents an individual piece of communication of the communication thread and includes first information related to the individual piece of communication and second information for authenticating a request to access the individual piece of communication. The communication controller is configured for receiving a request with third information from a user to access a specific piece of communication in the communication thread represented by a corresponding chain unit. The authentication unit is configured for authenticating the user requesting the access based on the third information and the second information included in the corresponding chain unit for the specific individual piece of communication. The storage management mechanism is configured for facilitating the user to access the specific piece of communication via the corresponding chain unit when the user is authenticated.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for communication. The information, when read by the machine, causes the machine to perform the following steps. A communication chain with multiple chain units is used to represent a communication thread involving multiple users. Each chain unit includes first information related to a piece of communication in the communication thread and second information for authenticating a request to access the piece of communication. When a request is received with third information from one of the users to access a specific piece of communication in the communication thread in a corresponding chain unit, the user is authenticated based on the third information and the second information in the chain unit for the specific piece of communication. The requested access is facilitated when the user is authenticated.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1B (PRIOR ART) illustrate how conventional communication service operates;

FIG. 2A depicts an exemplary blockchain-based communication service architecture, in accordance with an embodiment of the present teaching;

FIG. 2B depicts another exemplary blockchain-based communication service architecture, in accordance with a different embodiment of the present teaching;

FIG. 2C is a flowchart of an exemplary process of a blockchain-based communication service, in accordance with an embodiment of the present teaching;

FIG. 3A depicts an exemplary high level system diagram of a blockchain-based communication controller, in accordance with an embodiment of the present teaching;

FIG. 3B is a flowchart of an exemplary process of a blockchain-based communication controller, in accordance with an embodiment of the present teaching;

FIG. 4A depicts an exemplary high level system framework of a communication initiation unit, in accordance with an exemplary embodiment of the present teaching;

FIG. 4B is a flowchart of an exemplary process of a communication initiation unit, in accordance with an embodiment of the present teaching;

FIG. 5A depicts an exemplary high level system diagram for a communication corresponding unit, in accordance with an exemplary embodiment of the present teaching;

FIG. 5B is a flowchart of an exemplary process of a communication corresponding unit, in accordance with an exemplary embodiment of the present teaching;

FIG. 6A depicts an exemplary high level system diagram of a communication forwarding unit, according to an embodiment of the present teaching;

FIG. 6B is a flowchart of an exemplary process of a communication forwarding unit, according to an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

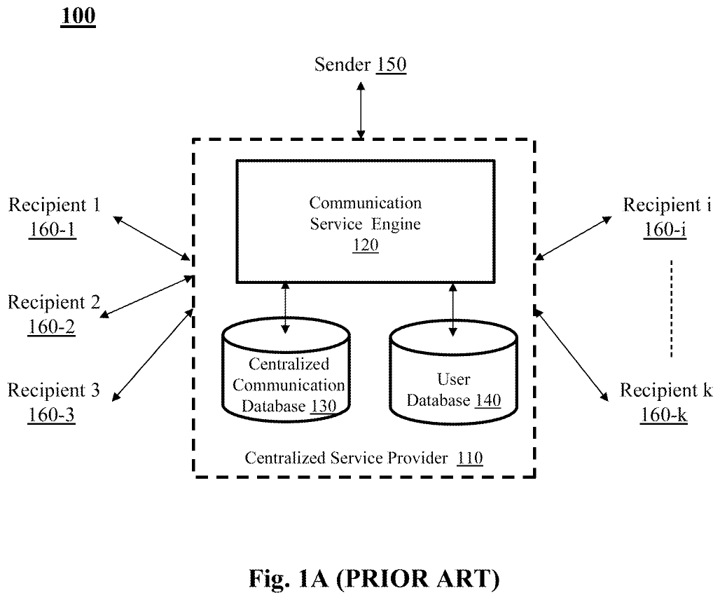

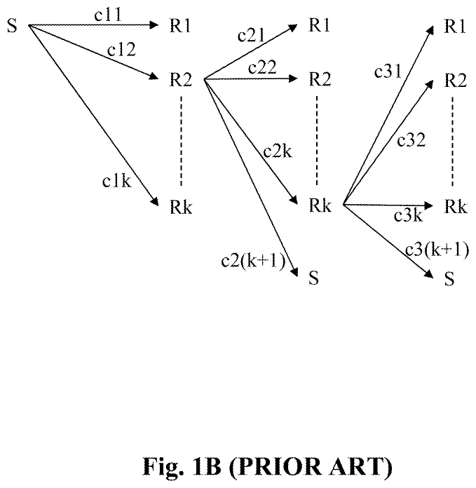

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a solution that addressed challenges in the art. To reduce the number of copies to save space and minimize bandwidth usage, the present teaching discloses a distributed or decentralized communication service framework. With this decentralized communication service framework, each piece of communication, whether it is an initial communication or a response, can be stored, upon being created, individually without multiple copies. Any subsequent access or modification to the piece of communication may be performed against the stored piece so that the need of creating multiple copies of the same communication is eliminated. Such stored communication may be encrypted so that any access to the communication may be achieved only when the communication can be correctly decrypted. In some embodiments, the access control may be enforced through the use of public/private encryption keys. A communication may be encrypted using a public key and can be shared with others such as recipients by sharing the private key with such recipients.

In some embodiments, in addition to controlled sharing of communication via encryption keys, additional types of access rights may be allocated to different recipients. Each piece of individually stored communication can be secured, i.e., its access or modification by another user can be further authenticated against certain access rights allocated to the other user. In this manner, each piece of communication is secure, and privacy is protected. When a sender user sends communication to recipients, access rights may be specified by the sender and accordingly enforced with respect to different recipient users in the same thread of communication. In some embodiments, the access rights include read, modification, forwarding, etc. A modification to a piece of communication may also be treated as a communication so that the modification may be stored separately from the communication that is modified by an authorized user. When a recipient user desires to forward a received communication to a secondary recipient user, the forwarding operation may be carried out by sharing the private key and may be subject to authentication on operations that a secondary recipient is authorized to perform. For instance, a forwarding recipient user may grant secondary access rights (e.g., right to modify or right to further forwarding) to each of the secondary recipient users. In some embodiments, such secondary access rights granted by a recipient user to a secondary recipient user may be limited to the access rights granted to the forwarding user, i.e., the recipient user.

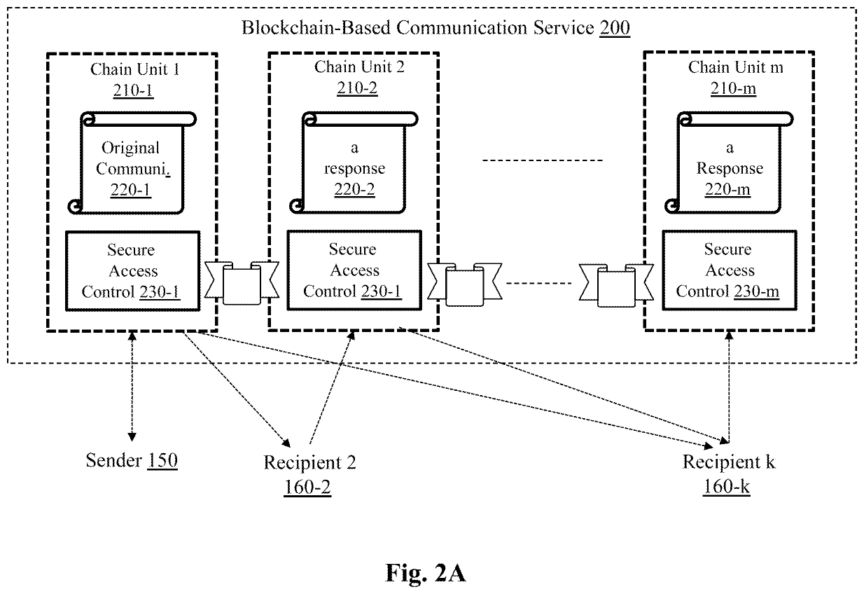

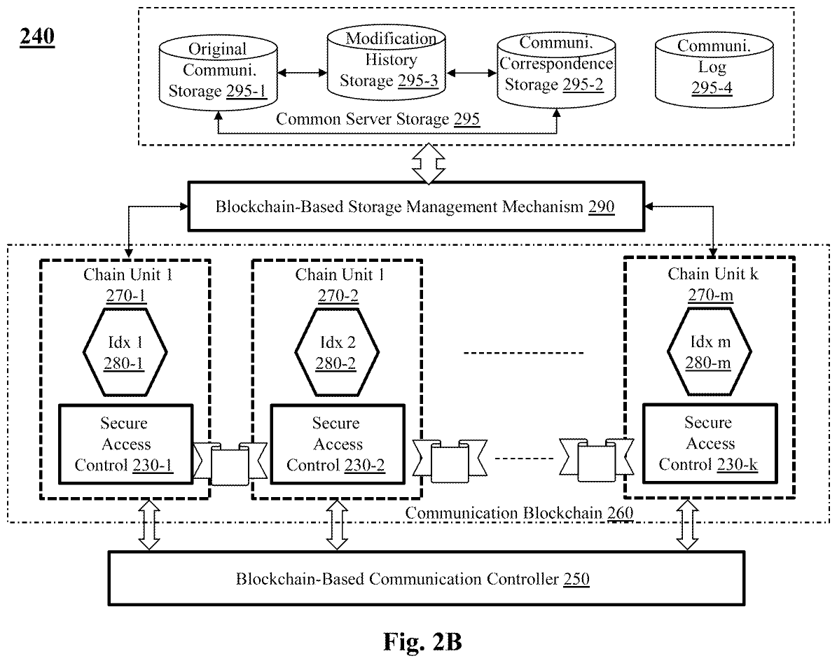

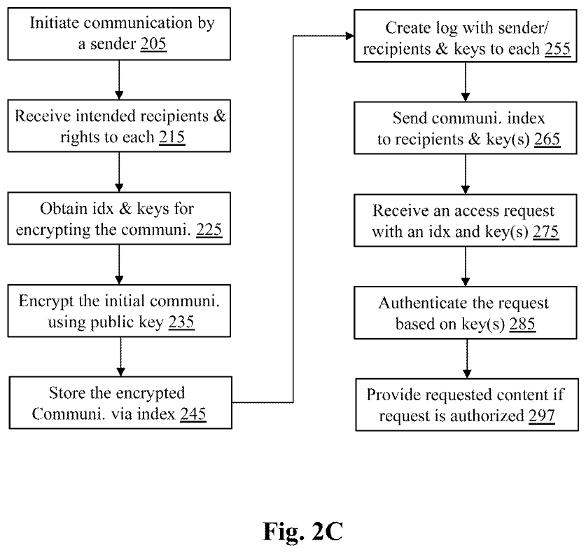

The decentralized communication service framework may be implemented using any platform that supports the functionalities that support decentralized communication services. In some embodiments, the decentralized communication service framework as disclosed herein according to the present teaching may be realized based on blockchain platform. FIG. 2A depicts an exemplary architecture for blockchain-based communication service 200, in accordance with an embodiment of the present teaching. In this illustrated embodiment, a plurality of users, whether senders or recipients of communications, interact with the blockchain-based communication service 200 to achieve communications. The blockchain-based communication service 200 comprises a plurality of chains representing different communication threads. In FIG. 2A, one example communication chain 210 is illustrated, which includes a chain unit 1 210-1, a chain unit 2 210-2, . . . , and a chain unit k 210-k. Depending on the progression of each of the communication threads, each chain may grow dynamically over time according to how the corresponding communication thread develops.

As shown in FIG. 2A, each of the chain unit in the communication chain 210 represents one piece of communication, whether it is an initial communication or a response. Different pieces of units may be chained according to, e.g., the time sequence of the pieces of communications they represent. For instance, in FIG. 2A, chain unit 1 210-1 may correspond to the initial communication of the thread created by a sender 150. After the initial communication is received by a plurality of k recipients, recipient 1 160-1, . . . , recipient k 160-k, any of this set of recipients may respond to the initial communication. For instance, as illustrated, recipient 2 16-2 may respond to the initial communication and the response from recipient 2 160-2 may be stored separately from the initial communication in chain unit 2 210-2. Such a response from recipient 2 160-2 may also be accessible to all recipients who received the initial communication from sender 150. Subsequently, recipient k 160-k may access the response from recipient 2 160-2 and decides to respond. The response from recipient k 160-k may then also be stored, separately from both chain unit 1 210-1 for the initial communication and chain unit 2 210-2 for the response from recipient 2 160-2, in a chain unit m 210-m in the blockchain. Thus, each piece of communication is stored and accessed separately without more copies of the same piece of communication being created. As illustrated in FIG. 2A, the initial communication generated by a sender 150 is stored in storage 220-1 of the chain unit 1 210-1, the response from recipient 2 160-2 in response to the initial communication from sender 150 is stored in communication storage 220-2 of the chain unit 2 210-2, . . . , and the response from recipient k 160-k in response to the response from recipient 2 160-2 is stored in the storage 220-m of the chain unit m 210-m.

As discussed herein, each piece of communication separately stored in a chain unit in 200 may be individually protected as to security and privacy and access to the piece of communication can be authenticated against certain access rights. As illustrated in FIG. 2A, each chain unit in the blockchain also includes a secure access control mechanism that is used to guard the piece of communication stored in the storage based on access rights stored therein. For example, chain unit 1 210-1 includes a storage 220-1 for storing communication content and a secure access control 230-1 which controls the access to the content stored in 220-1. Similarly, chain unit 2 210-2 includes storage 220-2 for strong communication content and a secure access control 230-2 that controls the access to the content stored in 220-2, etc.

Each secure access control mechanism in a chain unit may operate based on access right specifications provided by a creator of the content stored in the corresponding storage of the same chain unit. For example, when the sender 150 creates the initial communication to be sent to a list of recipients, the sender may send the content of the initial communication to the blockchain-based communication service 200. Upon receiving a request to initiate a communication thread, the blockchain-based communication service 200 creates a new chain unit for the initial communication, i.e., including the chain unit 1 210-1 as illustrated in FIG. 2A with the storage 220-1 and the secure access control 230-1. The content of the initial communication may then be encrypted using public key and the encrypted content is stored in the storage 220-1. The sender may also specify a list of recipients and the access rights to each. Such a specification may be stored in the secure access control 230-1 so that there is a record who is supposed to receive the initial communication with the private key and what additional access rights are granted to each of the recipients.

Similarly, when a recipient desires to react to a received communication thread (either a response or a modification to the initial communication or to a subsequent response), a new chain unit may be created and the content from the recipient (response or modification) may be stored in the storage of the new chain unit. In some embodiments, the access rights to the newly created content may inherit from what have been assigned to each. In some situations, a recipient may, if authorized to do so, forward the communication thread to a secondary recipient. In this situation, the content of what is stored in the chain unit created for the forwarding communication may be a pointer to the last chain unit of the communication thread being forwarded and the recipient may grant access rights to the secondary recipients within the scope of the access rights granted thereto.

In the embodiment illustrated in FIG. 2A, as the encrypted content of each piece of communication is stored within the blockchain, when a communication thread is long and with multiple branches, the blockchain may become burdensome due to continually increased volume, making management of the blockchain itself more involved. FIG. 2B depicts another exemplary blockchain-based communication service architecture 240, in accordance with a different embodiment of the present teaching. In this illustrated embodiment, the encrypted content of each piece of communication may be stored outside of the blockchain, e.g., in a common server storage and the chain units in the blockchain may store indices pointing to the common server storage. In this way, the blockchain itself can be made lightweight and the management thereof is more efficient. As shown in FIG. 2B, the alternative blockchain-based communication service architecture 240 comprises a blockchain-based communication controller 250, a communication blockchain 260, a blockchain-based storage management mechanism 290, and a common server storage 295.

The communication blockchain 260 includes a plurality of communication chains, each of which represents a communication thread. Each communication chain, e.g., chain 270 as shown in FIG. 2B, comprises a plurality of chain units, e.g., 270-1, 270-2, . . . , 270-m, corresponding to different pieces of communication involved in the same communication thread. In each chain unit, instead of providing a storage for storing encrypted content of a piece of communication, indexing information may instead be stored that provides, e.g., a pointer to a location in the common server storage where the piece of communication represented by the chain unit is stored. As shown in FIG. 2B, chain unit 1 270-1 stores idx 1 280-1, chain unit 2 280-2 stores idx 280-2, . . . chain unit m 270-m stores idx m 280-m. In operation, when content of the piece of communication represented by chain unit 1 270-1 is to be accessed, idx 1 280-1 stored therein is used to locate a memory space in the common server storage 295 wherein the content of the piece of communication is physically stored and can be retrieved. In this way, the storage needed for the chain units may be significantly reduced, leading to light weight blockchains. Similar to the chain unit in FIG. 2A, each chain unit in FIG. 2B includes a secure access control mechanism 230 with the similar functions as discussed herein for ensuring secure access to the piece of communication according the granted access rights.

The blockchain-based storage management mechanism 290 in the blockchain-based communication service architecture 240 is provided to map an index (stored in a chain unit in the communication blockchain 260) to a physical storage location in the common server storage 295 and then retrieve the content stored at the location. The retrieved content may then be provided to the chain unit that requests it so that the content may be forwarded to a user who request to access the content via the blockchain-based communication controller 250. In this manner, when the communication blockchain 260 grows with the progression of the communication threads, the size or volume of the communication blockchain 260 may remain manageable.

FIG. 2C is a flowchart of initiating a communication thread using the blockchain-based communication service 240, in accordance with an embodiment of the present teaching. A sender initiates, at 205 via, e.g., an interface with the blockchain-based communication controller 250, a communication thread by providing the initial communication and specifying a list of intended recipients with access rights to the recipients. When the blockchain-based communication controller 250 receives, at 215, the intended recipients and access rights to the same, the controller 250 creates a new chain unit for the initial communication and obtains, at 225, an index for the storage location in the common server and the encryption keys. The initial communication is encrypted using the obtained public key at 235 and the encrypted initial communication is then stored, at 245, in the common server storage based on the index. In some embodiments, the common server storage 295 may provide separate storage databases for different types of communications. For example, an original communication storage 295-1 may be provided to store all encrypted initial communications; a communication correspondence storage 295-2 may be provided for storing all responses to messages in communication threads; and a modification history storage 295-3 may be provided to store all modifications made to some communications, whether initial communications or responses, so that the original content of the communications that are being modified are not changed. To facilitate access to related information, content in different storages may be indexed so that the relationships among different pieces of information can be maintained to facilitate correct retrieval of relevant information.

To facilitate management of a new communication thread initiated by the sender 150, a communication log may be created, at 255, may be created for each new communication thread and may be initially populated with information related to, e.g., the sender, the recipients, the encryption keys, the reference identification to involved chain units, and optionally additional access rights allocated to different recipients. In some embodiments, the communication log created for each new communication thread may be stored in the common server storage 295 and may be dynamically updated with the progression of the communications. To effectuate the communication thread, the blockchain-based communication controller 250 sends, at 265, the index of the encrypted initial communication to recipients with appropriate keys according to the specification of the sender.

Once the initial communication is sent to the recipients, when the blockchain-based communication controller 250 receives, at 275, an access request with an index and appropriate private key, a corresponding chain unit is activated where the secure access control mechanism in that chain unit authenticates, at 285, the access request based on, e.g., the key received. If the request is authorized, the chain unit contacts the blockchain-based storage management mechanism 290 with the index and the private key so that the index may be used to derive the physical address in the common server storage where the encrypted content is stored. When the chain unit receives the retrieved content, it provides the requested content at 297 to the requesting user. Additional actions related to this initiated communication thread may also be performed via the blockchain-based communication service platform 240. Details of the blockchain-based communication controller 250 will be provided below to illustrate how different actions that can be performed during a communication thread may be supported and facilitated.

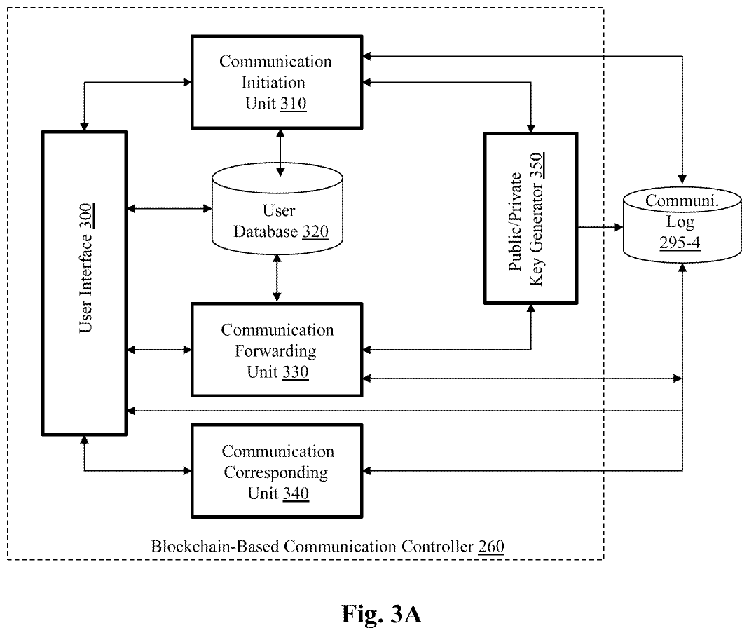

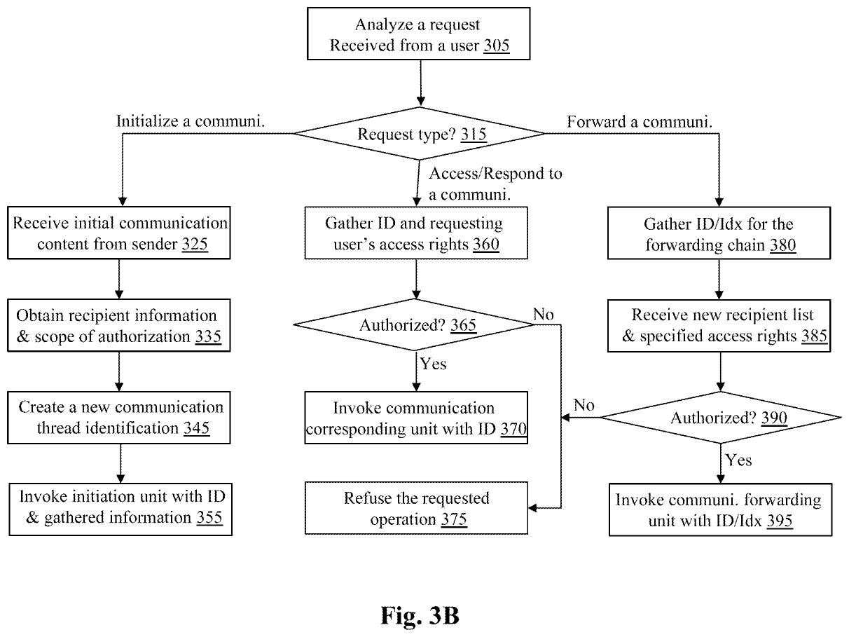

FIG. 3A depicts an exemplary high level system diagram of the blockchain-based communication controller 250, in accordance with an embodiment of the present teaching. In this illustrated embodiment, the blockchain-based communication controller 250 comprises a user interface 300, a communication initiation unit 310, a communication corresponding unit 340, a communication forwarding unit 330, and a public/private key generator 350. The user interface 300 is used to interact with users of the blockchain-based communication services and based on users' inputs, the user interface 300 may then trigger different functional blocks in FIG. 3A to carry out the requested services. In this illustrated embodiments, three types of service functions are included, e.g., services related to initiating a communication thread (performed by the communication initiation unit 310), services related to providing a response to a particular communication thread (performed by the communication corresponding unit 340), and services associated with forwarding a communication thread as of up to a certain point of time from one user to another (performed by the communication forwarding unit 330). This exemplary system diagram is merely for illustration and not to be interpreted as a limitation to the present teaching. Other functionalities associated with communication related services may also be included and so long as the service platform is decentralized or distributed in nature, such variations are all within the scope of the present teaching.

FIG. 3B is a flowchart of an exemplary partial process of the blockchain-based communication controller 250, in accordance with an embodiment of the present teaching. The user interface 300 is used to interact with users to handle various requests related to communication services. The exemplary flow as presented in FIG. 3B may represent some of the operational flows carried out by the blockchain-based communication controller 250. For instance, there may be more functional blocks included in the blockchain-based communication controller 250 and operational flows carried out by such additional functional blocks, e.g., there may be functional blocks that support the registration of new users with the services, store such new registration information in a user database 320 (see FIG. 3A), update maintenance choices when the system is upgraded, manage user relationships such as promotions, and removal of users under certain conditions. In FIG. 3B, the exemplary operational flows are directed to the functions related to servicing users involved in a communication thread based on the blockchain-based communication service platform as disclosed herein.

In operation, when the user interface 300 receives a service request from a user, it analyzes, at 305, the request in order to determine how to proceed. The analysis may also include certain checks on the user request, e.g., whether the request is from a user that is a registered user of the blockchain-based communication services. Based on the type of the received request, determined at 315, the user interface 300 may then invoke appropriate functional units to handle the request. As illustrated, if the request is for initiating a communication thread, i.e., from a user who desires to send a communication to one or more other users, the user interface 300 activates the communication initiation unit 310 and the processing flow proceeds to 325. If the request is for responding to a message in a communication thread, i.e., from a user who desires to respond to a previously received communication, the user interface 300 activates the communication corresponding unit 340 and the processing flow proceeds to 360. If the request is for forwarding some communication included in a communication thread to one or more secondary recipients from a user who is currently involved in the communication thread, the user interface activates the communication forwarding unit 330 and the processing flow proceeds to 385.

When the request is for initiating a communication thread, the user interface 300 interacts with the user to gather various related information, which includes receiving, at 325, content of the initial communication created by the sender user and obtaining, at 335, recipient information such as a list of recipients as well as the granted access rights to each recipient. In some embodiments, the access rights granted to each of the recipients may either be set based on system default or explicitly specified by the sender. The recipient information provided by the sender user may be checked against the information stored in the user database 320 to ensure that all recipients are users of the blockchain-based communication service platform. Upon relevant information gathered for initiating a new communication thread, the user interface 300 creates, at 345, a new communication thread with a unique identifier to be used to identify the communication thread and then invokes, at 355, the communication initiation unit 310 provides the identification of the new communication thread as well as the gathered relevant information needed for initiating a new communication thread. As discussed herein, the gathered information includes content of the initial communication, sender, specified recipients, as well as the access rights to be granted to each of the recipients.

When the request is for responding to a message in a communication thread, the user interface 300 interacts with the user to gather, at 360, various related information needed to facilitate the requested operation. For instance, information identifying the specific communication thread is needed. As another example, information about the requesting user may also be gathered so that his/her access rights related to the communication thread. Such gathered information may be used to check, at 365, whether the requesting user is authorized to perform the requested action. As discussed herein, user authorization information may be stored in the communication log created for each communication thread, which can be identified based on a unique identification. If the requesting user for responding to a communication is authorized to do so, the user interface 300 invokes, at 370, the communication corresponding unit 340 to carry out the requested operation. If the requesting user asking for responding to a communication is not authorized, the user interface 300 refuses, at 375, the requested service.

When the request is for forwarding a communication chain in a communication thread to secondary recipients, the user interface 300 interacts with the user to gather, at 380, the identifier of the communication thread as well as the index pointing to the last message of the communication chain to be forwarded. The user interface 300 also receives, at 385, the specification from the requesting user on a list of secondary recipients to whom the communication chain is to be forwarded as well as the access rights to be given to each of the secondary recipients. Using such gathered information, the user interface 300 may then check, at 390, whether the requesting user is authorized to perform the requested forwarding operation, which may include, e.g., whether the requesting user is authorized to forward the communication chain in question and whether the secondary recipients can be given the access rights as specified by the requesting user. When the requested forwarding operation is authorized, the user interface 300 invokes, at 395, the communication forwarding unit 330 to carry out the requested operation with gathered information such as the identification of the communication thread, the index pointing to the last message of a communication chain in the thread, the list of secondary recipients to receive the forwarded communication chain, as well as the rights specified to be granted to the secondary recipients. If the requested forwarding operation is not authorized, the user interface 300 proceeds to refuse, at 375, the requested operation.

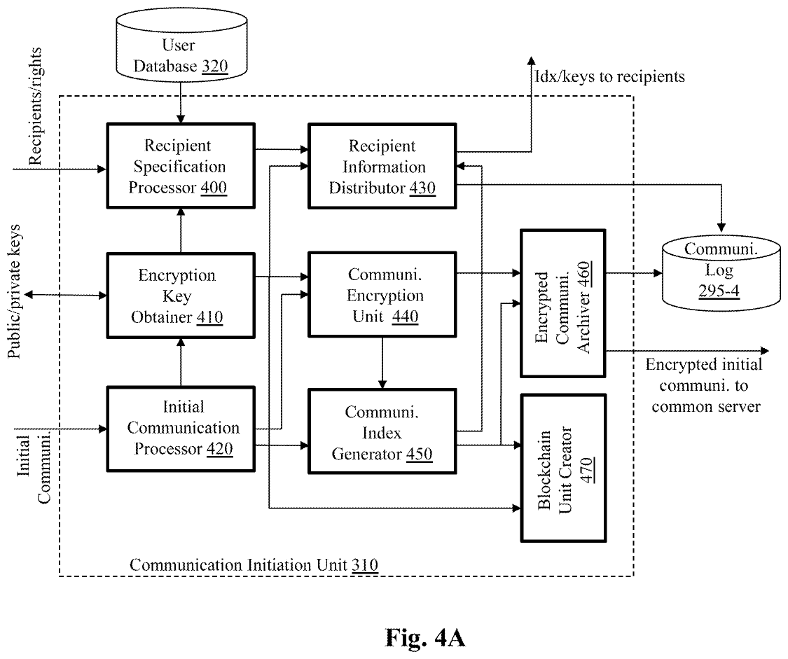

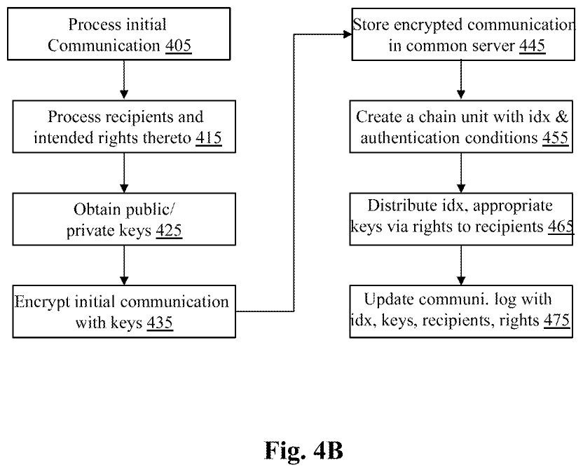

Below, details about different units in the blockchain-based communication controller 250 are provided with respect to FIGS. 4A-6C. FIG. 4A depicts an exemplary high level system framework of the communication initiation unit 310, in accordance with an exemplary embodiment of the present teaching. In this illustrated embodiment, the communication initiation unit 310 comprises a recipient specification processor 400, an encryption key obtainer 410, an initial communication processor 420, a communication encryption unit 440, a communication index generator 450, a blockchain unit creator 470, an encrypted communication archiver 460, and a recipient information distributor 430.

FIG. 4B is a flowchart of an exemplary process of the communication initiation unit 310, in accordance with an embodiment of the present teaching. When the communication initiation unit 310 received the initial communication and intended recipient list from the user interface 300, the initial communication processor 420 processes, at 405, the received initial communication and the recipient specification processor 400 processes, at 415, the intended list of recipients as well as the access rights granted to each. To facilitate the communication, the encryption key obtainer 410 obtains, at 425, the public and private keys to be used for encrypting/decrypting the initial communication. In some embodiments, the encryption key obtainer 410 requests and receives the public and private keys from the public/private key generator 350 (see FIG. 3A) and then forward to the communication encryption unit 440, which then encrypts, at 435, the initial communication using the public key. The encrypted initial communication is then stored, at 445 by the encryption communication archiver 460, in the common server storage 295.

The communication index generator 450 obtains an index pointing to a storage location in the common server storage 295 where the encrypted initial communication is to be stored. To establish a communication chain for the communication thread, a chain unit for the initial communication is created, at 455, by the blockchain unit creator 470. As discussed herein, the chain unit is populated with the index as a pointer and certain authentication information to be used to safeguard the chain unit based on, e.g., keys, recipient list and access rights thereto. The initial communication is then sent to the list of recipients specified by the sender. In some embodiments, the recipient information distributor 430 distributes, at 465, the index to the recipients with keys determined based on the access rights allocated to each recipient. As discussed herein, if a recipient is provided with a private key, the private key is used to decrypt the initial communication. In some embodiments, the communication activities related to a communication thread may be logged in a communication log created (by the user interface 300) for the communication thread. In this case, the recipient information distributor 430 may update, at 475, the communication log for the communication thread based on, e.g., the current operation performed with, e.g., index, keys, recipients involved, and the access rights granted thereto.

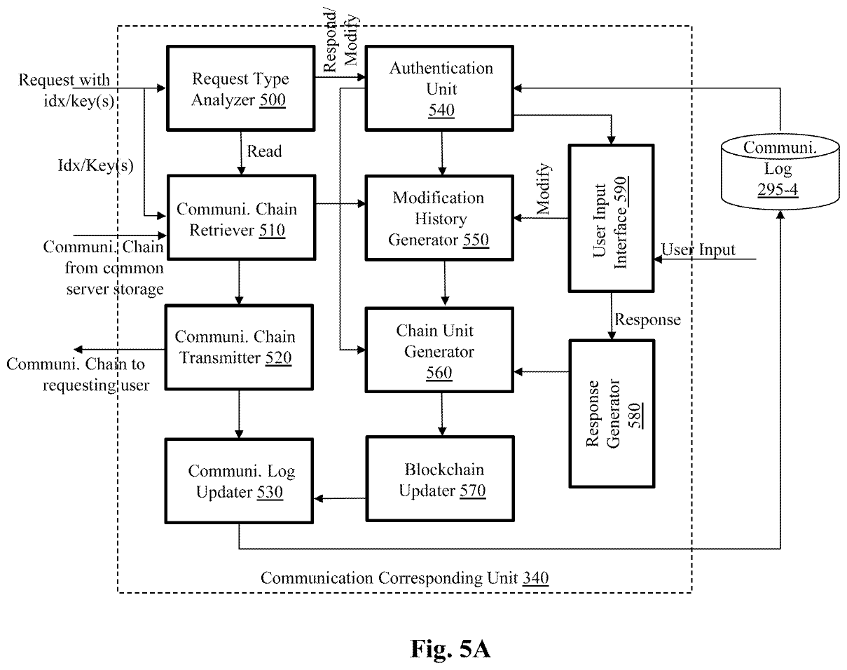

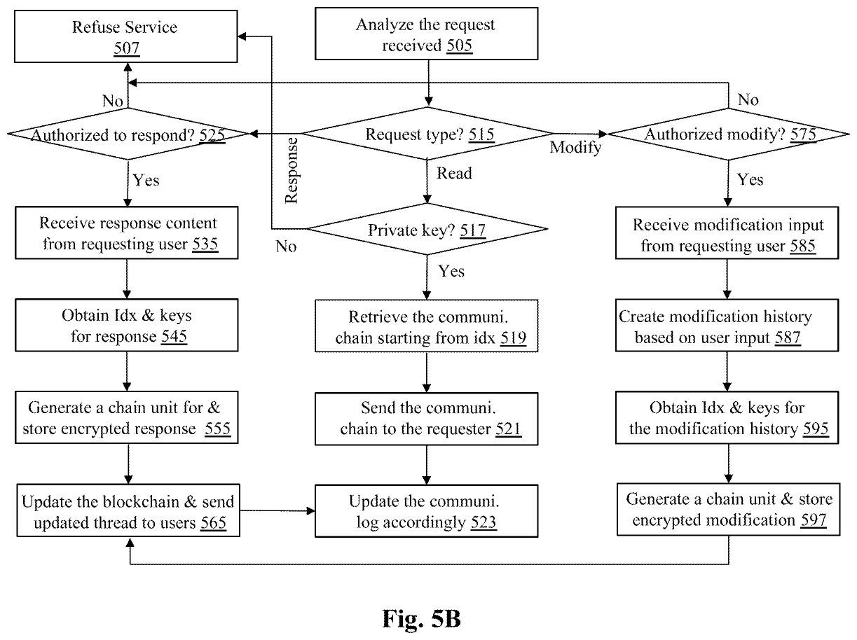

FIG. 5A depicts an exemplary high level system diagram for the communication corresponding unit 340, in accordance with an exemplary embodiment of the present teaching. The communication corresponding unit 340 is used to handle a user request to correspond in a communication thread. A correspondence can be of different types, including a request to access or read a communication chain, a request to respond to a message included in the communication chain, or a request to modify a message included in the communication chain. In this illustrated embodiment, the communication corresponding unit 340 comprises several different sub-processes, each of which is directed to handling a different type of request, including a read, respond, and a modify operation. Each of these operations is on a specified communication chain, which can be identified via, e.g., an index of the last message of the communication thread. For example, if a sender initial sent an email to 10 recipients and two recipients subsequently responded to the initial communication in a sequence, forming a communication chain having 3 linked chain units representing the initial message and two responses, respectively. In some embodiments, each updated communication chain may be sent to each recipient (including the sender) as an index, corresponding to the last chain unit in the current chain, which can be used to retrieve the entire communication chain by following the linked chain units. Given that, when a user (e.g., the sender or a recipient) requests the next access, the request may be sent with an index corresponding to where the access applies, where the request can be a read or a response to a communication chain ending at the index. In the case of modifying a message, the index of the piece of communication in the communication chain may be provided.

The illustrated system diagram of the communication corresponding unit 340 comprises a first portion for a request to access or read a communication chain determined based on a given index, a second portion for a request to respond to a communication chain represented by a given index, a third portion for a modification request to modify a message identified by an index, and a common operation portion for functions shared by different sub-parts. Specifically, in this illustrated embodiment, the portion of the communication corresponding unit 340 with shared functions comprises a request type analyzer 500, an authentication unit 540, a user input interface 590, an index/key generator 560, a blockchain updater 570, and a communication log updater 530. The first portion for a read request comprises a communication chain retriever 510 and a communication chain transmitter 520. The second portion for a response request includes a response generator 580 that generates a response based on user input corresponding to the content of the response. The third portion for a modifying request includes a modification history generator 550 that generates a modification history based on user input corresponding to modifications from the user to be applied to a message in the communication chain.

FIG. 5B is a flowchart of an exemplary process of the communication corresponding unit 340, in accordance with an exemplary embodiment of the present teaching. At 505, the request type analyzer 500 analyzes the received user request to determine the specific action to be carried out at 515. If the request is to access (read) a communication chain starting from a given index provided with the request, the communication chain retriever 510 is invoked and the process proceeds to 517. If the request is to respond to a message in the communication chain, the authentication unit 540 is invoked to make sure that the requesting user is authorized to respond to the indicated message and the process proceeds to step 525. If the request is to modify a message in the communication chain, the authentication unit 540 is also invoked to make sure that the requesting user is authorized to respond to the indicated message and the process proceeds to step 575.

In handling a read/access request in this exemplary process, the communication chain retriever 510 may first check, at 517, whether the request includes a private key. As discussed herein, a user may access a communication only if the user has a private key that matches with the public key used to encrypt the communication. If there is no private key, the requested service is refused at 507. If the private key is provided, the communication chain retriever 510 requests to retrieve, at 519, the content of the communication chain. In some embodiments, the retrieval process may involve identifying indices of messages in the communication chain from the blockchain units representing the communication chain, using the indices to retrieve corresponding encrypted pieces of communication, and decrypting the encrypted pieces of communication. Such retrieved communication chain may then be sent to the communication chain transmitter 520 that then sends, at 521, the retrieved communication chain to the requesting user. Then the communication chain transmitter 520 invokes the communication log updater 530 to update, at 523, the communication log associated with the communication thread.

In handling a response request according to this exemplary process, the authentication unit 540 is invoked to first check, at 525, whether the requesting user is authorized to perform the requested action to respond to a communication. In some embodiments, the authentication unit 540 may rely on the information recorded in the communication log 295-4 to perform the authentication. If the requesting user is not authorized to perform the action, the authentication unit 540 refuses the service at 507. If the requesting user is authorized to respond, the authentication unit 540 activates the user input unit 590 to receive, at 535, input from the requesting user and then send the input to the response generator 580 to generate the content of the response. To add the response to the blockchain for the communication thread, the chain unit generator 560 is invoked to create a chain unit for the response, including, e.g., obtaining, at 545, an index pointing to the common server storage 295 and the key(s) to encrypt and decrypt the response and generating, at 555, the chain unit with the index and other secure access information for authenticate any request to access the response and store the encrypted response in the common server storage 295. Based on the generated chain unit, the blockchain updater 570 may then, at 565, update the blockchain for the current communication thread (e.g., adding the newly created chain unit to the blockchain) and send the updated communication thread to all involved in the communication thread (e.g., both sender and the recipients). The communication log updater 530 then updates, at 523, the communication log for the communication thread according to the action just performed.

In handling a modifying request according to this exemplary process, the authentication unit 540 is also invoked to check, at 575, whether the requesting user is authorized to modify the content of a piece of communication. As discussed herein, the authentication unit 540 may rely on the information recorded in the communication log 295-4 to perform the authentication. If the requesting user is not authorized to perform the action, the authentication unit 540 refuses the service at 507. If the requesting user is authorized to modify, the authentication unit 540 activates the user input unit 590 to receive, at 585, modifications to be made from the requesting user and then send the requested modification to the modification history generator 550 to create, at 587, the modified piece of communication. To add the modification to the blockchain for the communication thread, the chain unit generator 560 is invoked to create a chain unit for the modification history, by, e.g., obtaining, at 595, an index pointing to the common server storage 295 for storing the modification history and the key(s) to encrypt and decrypt the modification and generating, at 597, the chain unit with the index and other secure access information for authentication and store the encrypted modification history in the common server storage 295. Based on the generated chain unit, the blockchain updater 570 may then, at 565, update the blockchain for the current communication thread (e.g., adding the newly created chain unit to the blockchain) and send the updated communication thread to all involved in the communication thread (e.g., both sender and the recipients). The communication log updater 530 then updates, at 523, the communication log for the communication thread according to the action just performed.

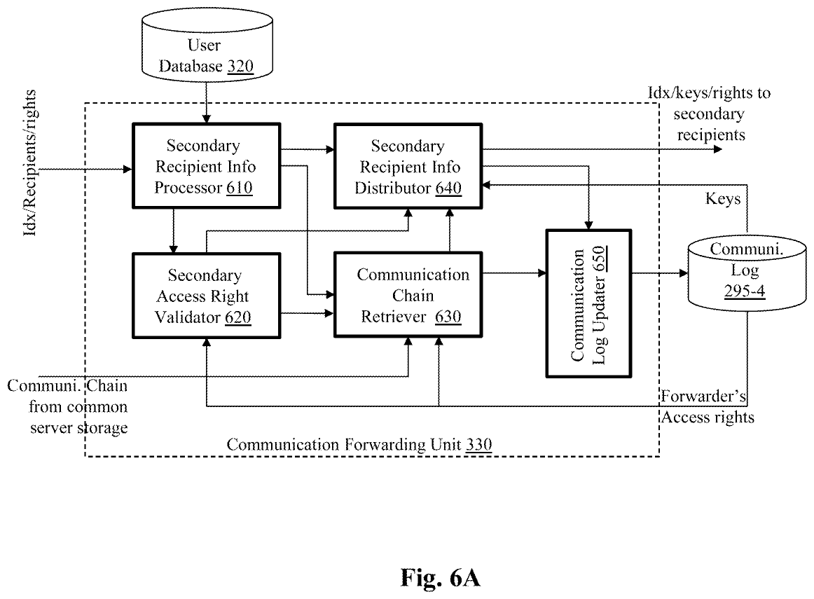

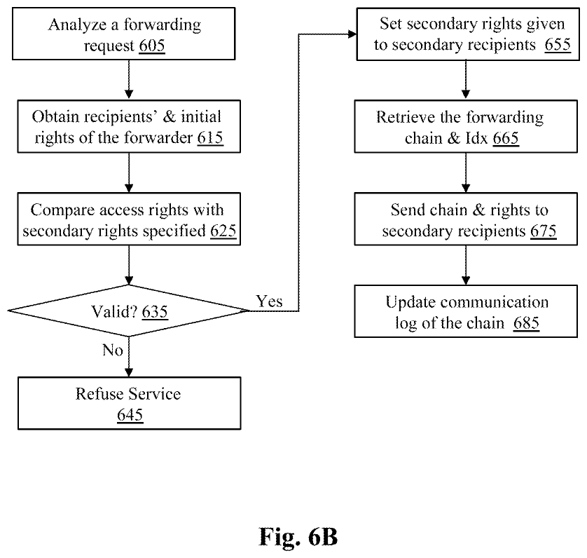

FIG. 6A depicts an exemplary high level system diagram of the communication forwarding unit 330, according to an embodiment of the present teaching. In this illustrated embodiment, the communication forwarding unit 330 comprises a secondary recipient information processor 610, a secondary access right validator 620, a communication chain retriever 630, a secondary recipient information distributor 640, and a communication log updater 650. FIG. 6B is a flowchart of an exemplary process of the communication forwarding unit 330, according to an embodiment of the present teaching. In operation, when the communication forwarding unit 330 is invoked to handle a request for forwarding a communication chain to one or more secondary recipients, the secondary recipient information processor 610 analyzes, at 605, the forwarding request to extract, e.g., the specified secondary recipients and the intended access rights assigned thereto. To validate the secondary rights granted to the secondary recipients, the secondary access right validator 620 obtains, at 615, the secondary rights to be granted to the secondary recipients (by the forwarding user) as well as the initial access rights granted to the forwarding user. These two groups of access rights may then be compared, at 625, to determine, at 635, whether the scope of the secondary access rights is valid.

In some embodiments, a forwarding user may grant access rights to a secondary recipient within the scope of his/her own access rights. For instance, if a forwarding user has access rights to read, to respond, to modify, and to forward or {read, respond, modify, forward}, the forwarding user may grant a secondary recipient any of {read, respond, modify, forward}, {read, respond, modify}, {read, respond, forward}, {read, modify, forward}, {read, respond}, {read, modify}, {read, forward}, and {read}. Similarly, if a forwarding user has access rights {read, respond, forward}, the forwarding user may grant a secondary recipient any of {read, respond, forward}, {read, respond}, {read, forward}, and {read}. Thus, the validity of the access rights granted from a forwarding user to a secondary recipient is determined based on whether the secondary rights specified by the forwarding user are within the recorded access rights (e.g., from the communication log 295-4) of the forwarding user.

If any of the scopes of the secondary access rights granted to the secondary recipients is not valid, the secondary access right validator 620 refuses, at 645, the requested forwarding service. If the scopes of the secondary access rights to the secondary recipients are all valid, the secondary access rights to each of the secondary recipients as specified are sent to the secondary recipient information distributor 640. The communication chain retriever 630 is invoked to retrieve, at 665, the communication chain (indices of the chain units therein) based on the index provided (representing the last message in a communication chain to be forwarded) and the retrieved communication chain is forwarded to the secondary recipient information distributor 640. With received list of secondary recipients (from the secondary recipient processor 610), the respective secondary access rights for the secondary recipients (from the secondary access right validator 620), and the communication chain (from the communication chain retriever 630), the secondary recipient information distributor 640 sends, at 675, the communication chain to each of the specified secondary recipients as well as the secondary access rights granted to each of the secondary recipients.

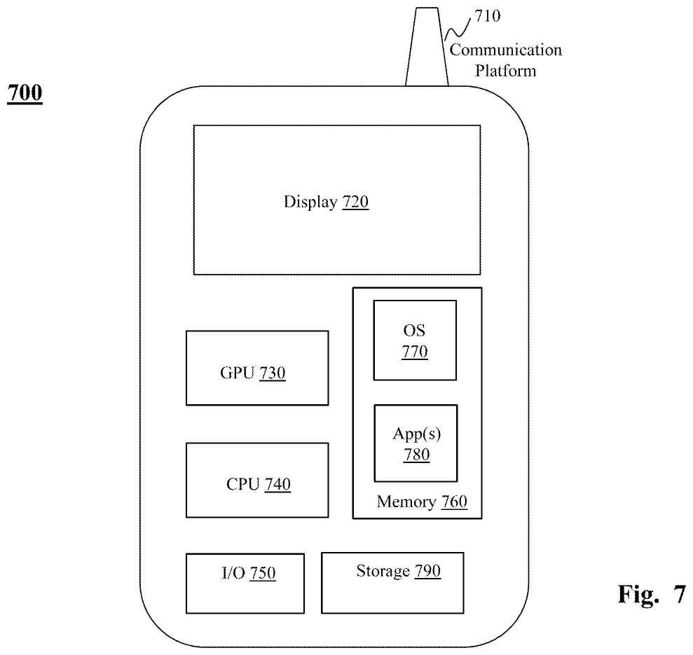

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

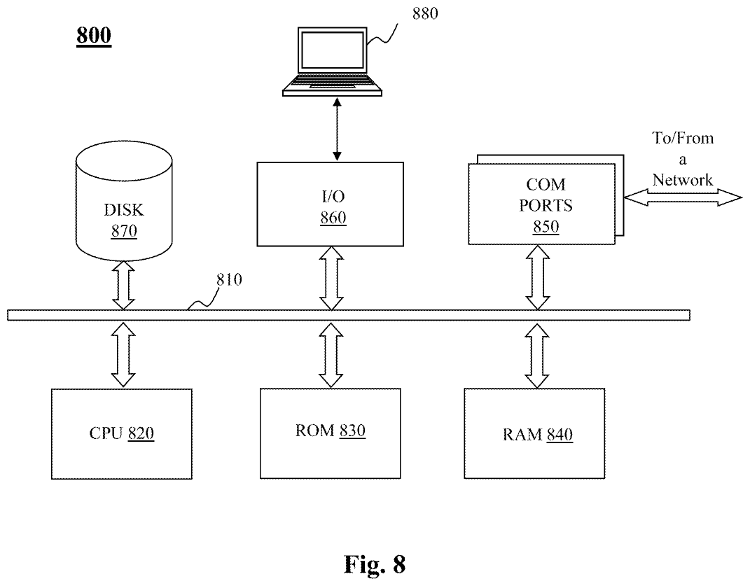

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for communication, comprising:
creating a communication chain representing a communication thread involving a plurality of users, wherein the communication chain comprises one or more chain units, each of which includes first information related to an individual piece of communication in the communication thread and second information for authenticating a request to access the individual piece of communication;
receiving a request with third information from one of the plurality of users to access a specific individual piece of communication in the communication thread represented by a corresponding chain unit;
authenticating the user requesting the access based on the third information and the second information included in the corresponding chain unit for the specific individual piece of communication; and
facilitating the user to access the specific piece of communication via the corresponding chain unit when the user is authenticated.

2. The method of claim 1, wherein
the communication chain corresponds to a blockchain; and
access to any of the pieces of communication in the blockchain is via the chain unit for the piece of communication.

3. The method of claim 1, wherein each of the chain units in the communication chain includes:
the first information is an index pointing to a storage location where an encrypted version of the corresponding individual piece of information is stored, wherein the encryption is performed using a public key; and
the second information specifies a condition to be met in order to access, via the index, the encrypted piece of information stored at the storage location, wherein the condition includes a private key.

4. The method of claim 3, wherein the condition further specifies one or more access rights needed in order to be authenticated.

5. The method of claim 1, wherein the third information includes at least a private key and an access right granted to the user requesting to access the specific piece of communication.

6. The method of claim 1, wherein the requested access to the specific piece of communication includes at least one of read, respond, modify, and forward.

7. The method of claim 6, wherein the user requests to forward the specific piece of communication by:
specifying at least one additional user to whom the specific piece of communication is to be forwarded; and
specifying secondary access rights to be granted to each of the at least one additional user to be applied in accessing the forwarded specific piece of communication, wherein
the secondary access rights granted to each of the at least one additional user is determined based on access rights previously granted to the user.

8. Machine readable and non-transitory medium having information recorded thereon for communication, wherein the information, when read by the machine, causes the machine to perform the following steps:
creating a communication chain representing a communication thread involving a plurality of users, wherein the communication chain comprises one or more chain units, each of which includes first information related to an individual piece of communication in the communication thread and second information for authenticating a request to access the individual piece of communication;
receiving a request with third information from one of the plurality of users to access a specific individual piece of communication in the communication thread represented by a corresponding chain unit;
authenticating the user requesting the access based on the third information and the second information included in the corresponding chain unit for the specific individual piece of communication; and
facilitating the user to access the specific piece of communication via the corresponding chain unit when the user is authenticated.

9. The medium of claim 8, wherein
the communication chain corresponds to a blockchain; and
access to any of the pieces of communication in the blockchain is via the chain unit for the piece of communication.

10. The medium of claim 8, wherein each of the chain units in the communication chain includes:
the first information is an index pointing to a storage location where an encrypted version of the corresponding individual piece of information is stored, wherein the encryption is performed using a public key; and
the second information specifies a condition to be met in order to access, via the index, the encrypted piece of information stored at the storage location, wherein the condition includes a private key.

11. The medium of claim 10, wherein the condition further specifies one or more access rights needed in order to be authenticated.

12. The medium of claim 8, wherein the third information includes at least a private key and an access right granted to the user requesting to access the specific piece of communication.

13. The medium of claim 8, wherein the requested access to the specific piece of communication includes at least one of read, respond, modify, and forward.

14. The medium of claim 13, wherein the user requests to forward the specific piece of communication by:
specifying at least one additional user to whom the specific piece of communication is to be forwarded; and
specifying secondary access rights to be granted to each of the at least one additional user to be applied in accessing the forwarded specific piece of communication, wherein
the secondary access rights granted to each of the at least one additional user is determined based on access rights previously granted to the user.

15. A system for communication, comprising:
a communication chain representing a communication thread involving a plurality of users, wherein the communication chain comprises one or more chain units, each of which includes first information related to an individual piece of communication in the communication thread and second information for authenticating a request to access the individual piece of communication;
a communication controller configured for receiving a request with third information from one of the plurality of users to access a specific individual piece of communication in the communication thread represented by a corresponding chain unit;
an authentication unit configured for authenticating the user requesting the access based on the third information and the second information included in the corresponding chain unit for the specific individual piece of communication; and
a storage management mechanism configured for facilitating the user to access the specific piece of communication via the corresponding chain unit when the user is authenticated.

16. The system of claim 15, wherein
the communication chain corresponds to a blockchain; and
access to any of the pieces of communication in the blockchain is via the chain unit for the piece of communication.

17. The system of claim 15, wherein each of the chain units in the communication chain includes:
the first information is an index pointing to a storage location where an encrypted version of the corresponding individual piece of information is stored, wherein the encryption is performed using a public key; and
the second information specifies a condition to be met in order to access, via the index, the encrypted piece of information stored at the storage location, wherein the condition includes a private key.

18. The system of claim 17, wherein
the condition further specifies one or more access rights needed in order to be authenticated; and
the third information includes at least a private key and an access right granted to the user requesting to access the specific piece of communication.

19. The system of claim 15, wherein the requested access to the specific piece of communication includes at least one of read, respond, modify, and forward.

20. The system of claim 19, wherein the user requests to forward the specific piece of communication by:
specifying at least one additional user to whom the specific piece of communication is to be forwarded; and
specifying secondary access rights to be granted to each of the at least one additional user to be applied in accessing the forwarded specific piece of communication, wherein
the secondary access rights granted to each of the at least one additional user is determined based on access rights previously granted to the user.
